(19) United States
(12) Patent Application Publication
(10) Pub. No.: US 2005/0135444 A1
(43) Pub. Date: Jun. 23, 2005

(54) Laser driver circuit and system

(76) Inventors: Anush A. Krishnaswami, San Diego, CA (US); Taesub Yoon, San Diego, CA (US)

Correspondence Address: INTEL CORPORATION, P.O. BOX 5326, SANTA CLARA, CA, 95056-5326, US

(21) Appl. No.: 10/742,377

(22) Filed: Dec. 19, 2003

(51) Int. Cl. H01S 3/00

(52) U.S. Cl. 372/38.02

(57) ABSTRACT

Described is a laser driver circuit comprising a bipolar transistor for transmitting a modulated power signal to a laser device. The bipolar transistor may generate the modulated power signal in response to a modulation current and a base current representative of a serial data signal. The laser driver circuit may further comprise a circuit to combine a replica of the base current with a reference modulation current to provide the modulation current.

### RELATED U.S. PATENT APPLICATIONS

The subject matter disclosed herein relates to U.S. pat. appl. Ser. No. 10/442,829, filed on May 21, 2003.

### BACKGROUND

1. Field

The subject matter disclosed herein relates to data communication systems. In particular, the subject matter disclosed herein relates to transmitting data in an optical transmission medium.

2. Information

Data transmission in an optical transmission medium such as fiber optic cabling has enabled communication at data rates of 10 gigabits per second and beyond according to data transmission standards set forth in IEEE Std. 802.3ae-2002, Synchronous Optical Network/Synchronous Digital Hierarchy (SONET) protocol as indicated in a set of standards provided by the American National Standards Institute (ANSI T1.105.xx) or Synchronous Digital Hierarchy (SDH) as indicated in a set of recommendations provided by the International Telecommunications Union (e.g., ITU-T G.707, G.708, G.709, G.783 and G.784). To transmit data in the optical transmission medium, a laser device typically modulates an optical signal in response to a data signal. The laser device typically modulates the optical signal using wave division multiplexing (WDM) in response to the data signal.

FIG. 1 shows a schematic diagram of a prior art laser driver circuit 50 to provide a modulation current 60 to a laser device 58. The laser driver circuit 50 may be formed in a single complementary metal oxide semiconductor (CMOS) device. The laser device 58 receives a bias current 62 combined with a modulated power signal to power the transmission of an optical signal in an optical transmission medium. The modulated power signal is generated by a switch transistor 66 formed as a field effect transistor (FET). As such, the switch transistor 66 selectively transmits the modulation current I_{MOD} to be combined with the bias current 62 based upon a voltage applied to a gate terminal of the switch transistor 66. The laser device 58 typically also modulates the optical signal in response to a data signal. The laser driver circuit receives a reference current 52 generated by, for example, a controlled voltage source applied across an off-chip resistor. A diode coupled FET 54 and FET 56 form a current mirror to generate the modulation current 60 at a magnitude that is substantially proportional to the magnitude of the input reference current 52.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a prior art laser driver circuit.

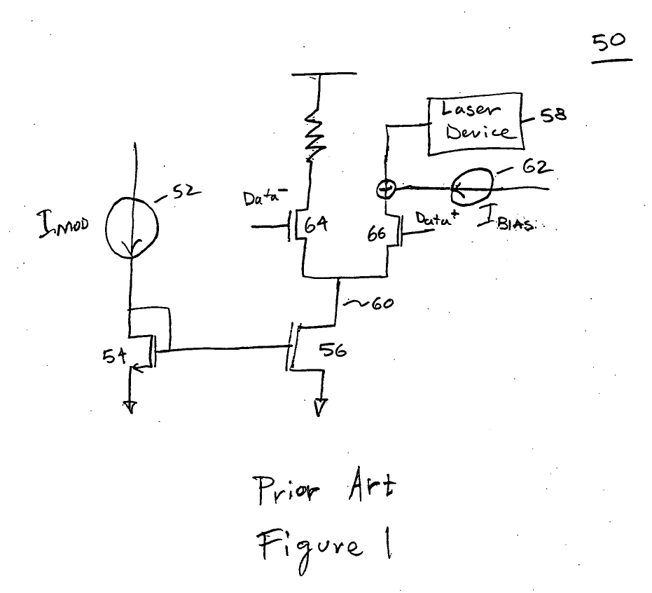

FIG. 2 shows schematic diagram of a system to transmit in and receive data from an optical transmission medium according to an embodiment of the present invention.

FIG. 3 shows a schematic diagram of physical medium attachment and physical medium dependent sections of a data transmission system according to an embodiment of the system shown in FIG. 2.

FIG. 4 shows a schematic diagram of a laser driver circuit according to an embodiment of the physical medium dependent section shown in FIG. 4.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

An “optical transmission medium” as referred to herein relates to a transmission medium capable of transmitting light energy in an optical signal which is modulated by a data signal such that the data signal is recoverable by demodulating the optical signal. For example, an optical transmission medium may comprise fiber optic cabling coupled between a transmitting point and a receiving point. However, this is merely an example of an optical transmission medium and embodiments of the present invention are not limited in this respect.

A “laser device” as referred to herein relates to a device to transmit a light signal in response to a power source. For example, a laser device may transmit a light signal in an optical transmission medium which is modulated by a data signal. A laser device may comprise a laser diode to transmit a light signal in response to a current. However, these are merely examples of a laser device and embodiments of the present invention are not limited in these respects.

A “laser driver circuit” as referred to herein relates to a circuit to provide power to a laser device to be used for transmitting a light signal in an optical transmission medium. For example, a laser driver circuit may provide a controlled current signal to provide power for transmitting the light signal. However, this is merely an example of a laser driver circuit and embodiments of the present invention are not limited in these respects.

A laser driver circuit may provide a current signal to a laser device having a “bias current” component combined with a “data current” component which is modulated by a data signal. The data current may be generated by modulating a “modulation current” with the data signal. The modulation current may determine an extent to which the magnitude of the current signal may deviate from the bias current component. However, these are merely examples of a bias current and modulation current, and embodiments of the present invention are not limited in these respects.

A “reference modulation current” as referred to herein relates to a current signal having a magnitude that approximates a magnitude of a desired modulation current. For example, a reference modulation current may have a magnitude that is tailored to provide a data current signal according to specific characteristics of a laser device and a desired intensity of a light signal to be generated by the laser device to represent a data signal. However, this is merely an example of a reference modulation current and embodiments of the present invention are not limited in this respect.

A “transistor” as referred to herein relates to an active solid state device to generate an output current having a magnitude that is based upon an input signal. A “bipolar transistor” as referred to herein relates to a transistor that generates an output current having a magnitude that is based upon a current applied to a base terminal of the transistor. A “field effect transistor” (FET) as referred to herein relates to a transistor that generates an output current having a magnitude that is based upon a voltage applied to a gate terminal of the transistor. However, these are merely examples of a transistor, bipolar transistor and FET, and embodiments of the present invention are not limited in these respects.

A “photodiode” as referred to herein relates to a device that provides an output current in response to light energy collected on a surface. For example, a photodiode may provide an output voltage or an output current in response to charge collected at a photodiode gate. However, this is merely an example of a photodiode and embodiments of the present invention are not limited in this respect.

Briefly, an embodiment of the present invention relates to a laser driver circuit comprising a bipolar transistor for transmitting a modulated power signal to the laser device. The bipolar transistor may generate the modulated power signal in response to a modulation current and a base current representative of a serial data signal. The laser driver circuit may further comprise a circuit to combine a replica of the base current with a reference modulation current to provide the modulation current. However, this is merely an example embodiment and other embodiments are not limited in these respects.

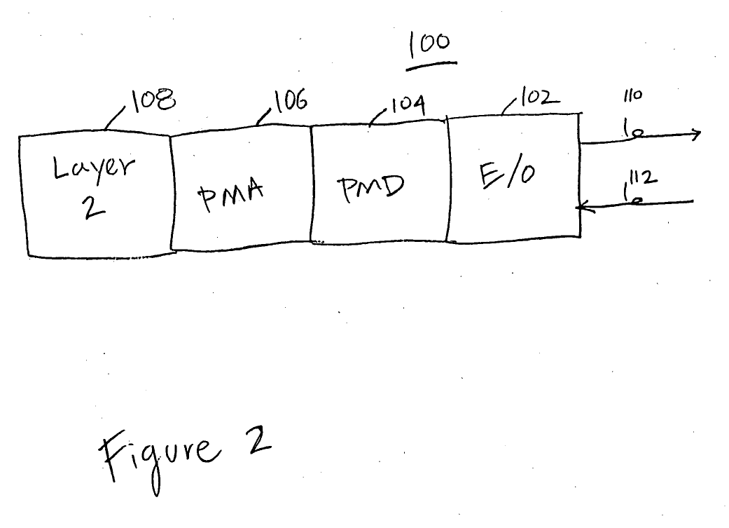

FIG. 2 shows a schematic diagram of a system to transmit in and receive data from an optical transmission medium according to an embodiment of the present invention. An optical transceiver 102 may transmit or receive optical signals 110 or 112 in an optical transmission medium such as fiber optic cabling. The optical transceiver 102 may modulate the transmitted signal 110 or demodulate the received signal 112 according to any optical data transmission format such as, for example, wave division multiplexing wavelength division multiplexing (WDM) or multi-amplitude signaling (MAS). For example, a transmitter portion (not shown) of the optical transceiver 102 may employ WDM for transmitting multiple “lanes” of data in the optical transmission medium.

A physical medium dependent (PMD) section 104 may provide circuitry, such as a transimpedance amplifier (TIA) (not shown) and/or limiting amplifier (LIA) (not shown), to receive and condition an electrical signal from the optical transceiver 102 in response to the received optical signal 112. The PMD section 104 may also provide to a laser device (not shown) in the optical transceiver 102 power from a laser driver circuit (not shown) for transmitting an optical signal. A physical medium attachment (PMA) section 106 may include clock and data recovery circuitry (not shown) and de-multiplexing circuitry (not shown) to recover data from a conditioned signal received from the PMD section 104. The PMA section 106 may also comprise multiplexing circuitry (not shown) for transmitting data to the PMD section 104 in data lanes, and a serializer/deserializer (Serdes) for serializing a parallel data signal from a layer 2 section 108 and providing a parallel data signal to the layer 2 section 108 based upon a serial data signal provided by the clock and data recovery circuitry.

According to an embodiment, the layer 2 section 108 may comprise a media access control (MAC) device coupled to the PMA section 106 at a media independent interface (MII) as defined IEEE Std. 802.3ae-2002, clause 46. In other embodiments, the layer 2 section 108 may comprise forward error correction logic and a framer to transmit and receive data according to a version of the Synchronous Optical Network/Synchronous Digital Hierarchy (SONET) protocol as indicated in a set of standards provided by the American National Standards Institute or Synchronous Digital Hierarchy (SDH) as indicated in a set of recommendations provided by the International Telecommunications Union. However, these are merely examples of layer 2 devices that may provide a parallel data signal for transmission on an optical transmission medium, and embodiments of the present invention are not limited in these respects.

The layer 2 section 108 may also be coupled to any of several input/output (I/O) systems (not shown) for communication with other devices in a processing platform. Such an I/O system may include, for example, a multiplexed data bus coupled to a processing system or a multi-port switch fabric. The layer 2 section 108 may also be coupled to a multi-port switch fabric through a packet classifier device. However, these are merely examples of an I/O system which may be coupled to a layer 2 device and embodiments of the present invention are not limited in these respects.

The layer 2 device 108 may also be coupled to the PMA section 106 by a backplane interface (not shown) over a printed circuit board. Such a backplane interface may comprise devices providing a 10 Gigabit Ethernet Attachment Unit Interface (XAUI) as provided in IEEE Std. 802.3ae-2002, clause 47. In other embodiments, such a backplane interface may comprise any one of several versions of the System Packet Interface (SPI) as defined by the Optical Internetworking Forum (OIF). However, these are merely examples of a backplane interface to couple a layer 2 device to a PMA section and embodiments of the present invention are not limited in these respects.

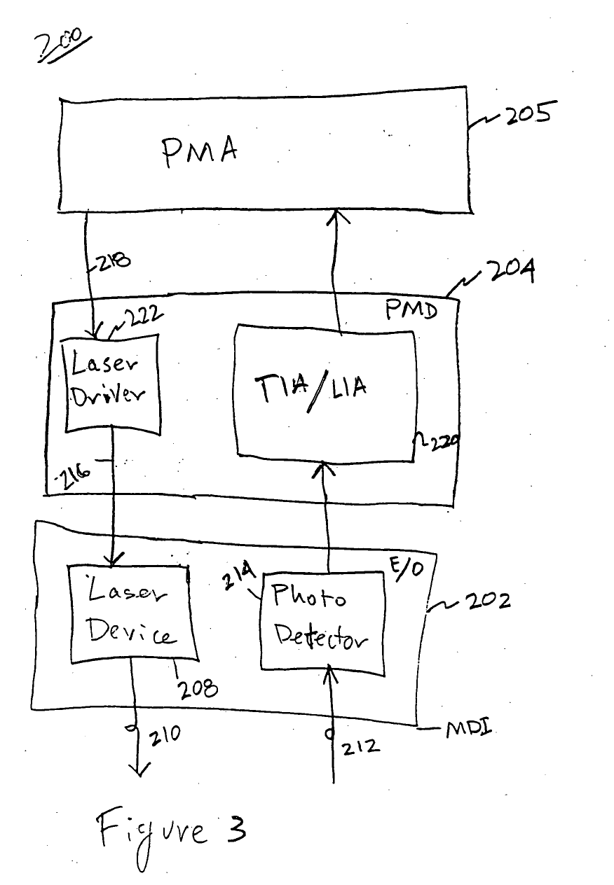

FIG. 3 shows a schematic diagram of a system 200 to transmit data in and receive data from an optical transmission medium according to an embodiment of the system shown in FIG. 2. An optical transceiver 202 comprises a laser device 208 to transmit an optical signal 210 in an optical transmission medium and a photo detector section 214 to receive an optical signal 212 from the optical transmission medium. The photo detector section 214 may comprise one or more photodiodes (not shown) for converting the received optical signal 212 to one or more electrical signals to be provided to a TIA/LIA circuit 220. A laser driver circuit 222 may provide a current signal 216 to the laser device 208 in response to a data signal from a PMA section 205. The laser device 208 may then transmit optical signal 210 in response to the current signal 216.

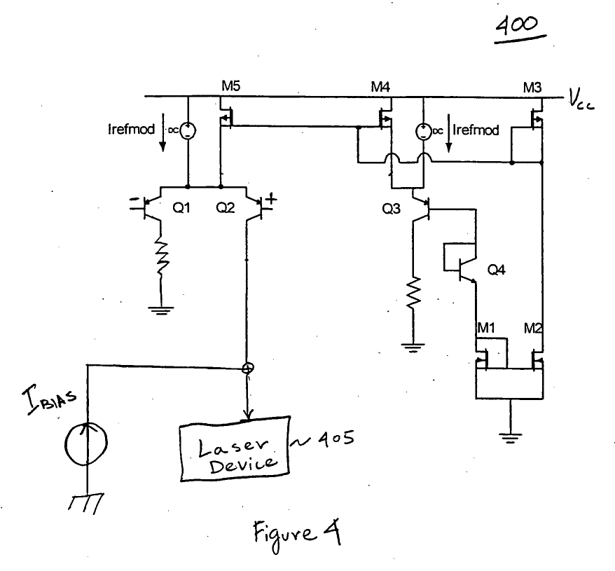

FIG. 4 shows a schematic diagram of a laser driver circuit 400 according to an embodiment of the laser driver circuit 222 shown in FIG. 3. According to an embodiment, the laser driver circuit 400 may be formed using a BiCMOS process to enable the formation of bipolar and field effect transistors on the same semiconductor device. Bipolar transistors may enable increased current switching speed over the use of field effect transistors. A bipolar transistor Q2 may generate a data current in response to a data signal (e.g., data signal 218 as shown in FIG. 3) received at the base terminal of bipolar transistor Q2. The data signal may be received at the base terminals of both bipolar transistors Q1 and Q2 such that the bipolar transistor Q2 is turned on to generate a current for a “1” and bipolar transistor Q1 is turned on to transmit a current to ground for a “0.” The data current generated by bipolar transistor Q2 may be additively combined with a bias current I_{BIAS} to generate a power signal for powering a laser device 405.

A reference modulation current Irefmod may be applied to the emitter terminals of bipolar transistors Q1, Q2 and Q3. According to an embodiment, the output data current of the bipolar transistor Q2 (in response to a data signal of “1”) to be combined with bias current I_{BIAS} has a magnitude that is substantially equal to the magnitude of the reference modulation current Irefmod. Accordingly, a transistor M5 may generate a current that is substantially equal to a base current loss from the base terminal of bipolar transistor Q2.

According to an embodiment, the bipolar transistors Q1, Q2 and Q3 may be formed substantially identically and behave substantially the same in response to process, temperature and power supply variations. Transistors M3, M4 and M5 are mirror coupled such that they generate the same current in response to a gate voltage. The current at the base terminal of transistor bipolar transistor Q3 is substantially equal to the current at the base terminal of bipolar transistor Q2. This current at the base terminal of bipolar transistor Q3 is then measured and mirrored by transistors M1, M2 and M3 to feedback the base current loss to mirror coupled transistors M4 and M5. Accordingly, the M5 current provides the base loss current back to the emitter terminal of bipolar transistor Q2.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

1. A system comprising:
a serializer to provide a serial data signal in response to a parallel data signal;
a laser device adapted to be coupled to an optical transmission medium to transmit an optical signal in the optical transmission medium; and
a laser driver circuit, the laser driver circuit comprising:
a bipolar transistor to provide a data current to the laser device in response to a modulation current and a base current representative of the serial data signal; and
a circuit to combine a replica of the base current with a reference modulation current to provide the modulation current.

2. The system of claim 1, the system further comprising a SONET framer to provide the parallel data signal.

3. The system of claim 2, wherein the system further comprises a switch fabric coupled to the SONET framer.

4. The system of claim 1, the system further comprising an Ethernet MAC to provide the parallel data signal at a media independent interface.

5. The system of claim 4, wherein the system further comprises a multiplexed data bus coupled to the Ethernet MAC.

6. The system of claim 4, wherein the system further comprises a switch fabric coupled to the Ethernet MAC.

7. A method comprising:
generating a reference modulation current;
providing a data current to a laser device in response to a modulation current and a base current at a base terminal of a first bipolar transistor, the base current being representative of a data signal; and
combining a replica of the base current with a reference modulation current to provide the modulation current.

8. The method of claim 7, the method further comprising generating the replica of the base current at a base terminal of a replica of the first bipolar transistor.

9. The method of claim 8, the method further comprising transmitting the replica of the base current via a current mirror circuit to combine the replica of the base current with the reference modulation current

10. The method of claim 9, wherein the current mirror circuit comprises a first field effect transistor (FET) coupled to an emitter terminal of the bipolar transistor and a second FET coupled to the replica of the first bipolar transistor.

11. The method of claim 7, the method further comprising selectively transmitting a the combination of the replica of the base current and the reference modulation current to a ground node via a second bipolar transistor in response to the data signal.

12. The method of claim 11, the method further comprising selectively transmitting the combination of the replica of the base current and the reference modulation current modulated to the laser device via the first bipolar transistor in response to the data signal.

13. The method of claim 7, the method further comprising
combining the data current with a bias current to provide a power signal; and
transmitting the power signal to the laser device.

14. A binary switching circuit comprising:
a first bipolar transistor to provide a modulated power signal in response to a modulation current and a base current representative of a data signal; and
a circuit to combine a replica of the base current with a reference modulation current to provide the modulation current.

15. The binary switching circuit of claim 14, wherein the binary switching circuit further comprises a replica of the first bipolar transistor comprising a base terminal to generate the replica of the base current.

16. The binary switching circuit of claim 14, the binary switching circuit further comprising a current mirror circuit to transmit the replica of the base current to the circuit to combine the replica of the base current with the reference modulation current.

17. The binary switching circuit of claim 16, wherein the binary switching circuit comprises a first field effect transistor (FET) coupled to an emitter terminal of the bipolar transistor and a second FET coupled to the replica of the first bipolar transistor.

18. The binary switching circuit of claim 14, wherein the binary switching circuit further comprises a second bipolar transistor to selectively transmit the combination of the replica of the base current and the reference modulation current modulated to a ground node in response to the data signal.

19. A laser driver circuit comprising:
a circuit to generate a reference modulation current;
a first bipolar transistor to provide a data current to a laser device in response to a modulation current and a base current representative of a data signal; and
a circuit to combine a replica of the base current with a reference modulation current to provide the modulation current.

20. The laser driver circuit of claim 19, wherein the laser driver circuit further comprises a replica of the first bipolar transistor comprising a base terminal to generate the replica of the base current.

21. The laser driver circuit of claim 19, the laser driver circuit further comprising a current mirror circuit to transmit the replica of the base current to the circuit to combine the replica of the base current with the reference modulation current

22. The laser driver circuit of claim 21, wherein the current mirror circuit comprises a first field effect transistor (FET) coupled to an emitter terminal of the bipolar transistor and a second FET coupled to the replica of the first bipolar transistor.

23. The laser driver circuit of claim 19, wherein the laser driver circuit further comprises a second bipolar transistor to selectively transmit the combination of the replica of the base current and the reference modulation current modulated to a ground node in response to the data signal.

24. The laser driver circuit of claim 23, wherein the first bipolar transistor is adapted to selectively transmit the combination of the replica of the base current and the reference modulation current modulated to a laser device in response to the data signal.

25. The laser driver circuit of claim 19, the laser driver circuit further comprising a circuit to combine the modulation with a bias current for powering a laser device.
